(19) United States
(12) Patent Application Publication
(10) Pub. No.: US 2012/0043293 A1
(43) Pub. Date: Feb. 23, 2012

(54) Nipple For An Infant Bottle Assembly And An Infant Bottle Assembly Having Such a Nipple

(75) Inventors: Raymond G. Bryan, Reno, NV (US); Jimi Francis, Sparks, NV (US)

(73) Assignee: HANDI-CRAFT COMPANY, St. Louis, MO (US)

(21) Appl. No.: 13/283,923

(22) Filed: Oct. 28, 2011

Related U.S. Application Data
(62) Division of application No. 13/112,162, filed on May 20, 2011.
(60) Provisional application No. 61/347,151, filed on May 21, 2010.

(51) Int. Cl. A61J 9/00; A61J 11/00

(52) U.S. Cl. 215/11.1

(57) ABSTRACT

A nipple for use with a nursing bottle is provided. The nipple includes a base portion and a bulbous sidewall connected to and extending upward from the base portion. The bulbous sidewall has a height and a maximum width that is larger than said height. The nipple further includes an end portion extending upward from the bulbous sidewall and having an outlet opening therein.

### CROSS REFERENCE TO RELATED APPLICATION

This application claims priority to patent application Ser. No. 13/112,162 filed May 20, 2011, which claims the priority of Provisional Patent Application Ser. No. 61/347,151 entitled “NIPPLE FOR AN INFANT BOTTLE ASSEMBLY HAVING A FLOW CONTROL VALVE AND AN INFANT BOTTLE ASSEMBLY HAVING SUCH A NIPPLE”, filed May 21, 2010, both of which are hereby incorporated by reference in their entireties.

### BACKGROUND

The field of this invention relates generally to bottle assemblies and more particularly to a nipple for a bottle assembly having a flow control valve.

Bottle assemblies, such as infant bottle assemblies, typically have multiple components including a bottle, a nipple, a collar for securing the nipple to the bottle, and a cap for covering the nipple when the bottle is not in use. The nipple typically has one or more openings for allowing liquid contained within the bottle to exit through the nipple and into an infant's mouth for consumption by the infant (or young child). During use, the infant places an end of the nipple in their mouth and sucks on the nipple to withdraw the liquid contained within the bottle.

In conventional infant bottle assemblies, the flow of liquid through the nipple is often controlled by the size and/or number of openings formed in the end of the nipple. To change the flow rate of most bottle assemblies, the entire nipple has to be replaced with a different nipple having the desired flow rate. Often, manufacturers of bottle assemblies will provide a series of nipples with different sizes and/or number of openings that are suitable for use with their bottles. For example, it is common for manufacturers to provide nipples having three different flow rates for use with their bottle assemblies. Often, a first low-flow nipple is provided wherein the nipple has a single, relatively small opening therein for allowing only a low flow of liquid to pass through. Low-flow nipples are typically designed for use by infants less than 3 months of age. A second medium-flow nipple may be provided wherein the nipple has two or more openings and/or the opening(s) in the nipple are larger than those in the low-flow nipple. Medium-flow nipples are typically designed for use by infants between 3 months and 6 months of age. A third high-flow nipple may be provided wherein the nipple has a plurality of openings and/or the opening(s) in the nipple are larger than those in the medium-flow nipple. High-flow nipples are typically designed for use by infants over 6 months of age.

One issue that has not been addressed with these variable flow nipples is the issue of over-feeding. Recent research reports indicate that infants using bottles are consistently over-fed and at higher risk for early childhood obesity. Bottle-fed infants have significantly higher caloric intake than infants fed at the breast. See, e.g., Ziegler E E., Growth of breast-fed and formula-fed infants, Nestle Nutr Workshop Ser Pediatr Program 2006; 58:51-59; Li R, Fein S B, Grumm-Strawn L M., Association of breastfeeding intensity and bottle-emptying behaviors at early infancy with infant's risk for excess weight at late infancy, Pediatrics 2008; 122 (Suppl 2):577-584; and Noble S, Emmett P., Differences in weaning practice, food and nutrient intake between breast-and formula-fed 4-month-old infants in England, J Hum Nutr Diet 2006; 19(4):303-13. The difference in energy intake results in increased adiposity in bottle-fed infants. See, e.g., Bonuck K A, Huang V, Fletcher J., Inappropriate bottle use: an early risk for overweight? Literature review and pilot data for a bottle-weaning trial, Matern Child Nutr 2010; 6(1):38-52 and Koletzko B, von Kries R, Closa R, Escribano J, Scaglioni S, Giovannini M, Beyer J, Demmelmair H, Anton B, Grusfeld D, Dobrazanska A, Sengier A, Langhedries J P, Rolland Cachera M F, Grote V., Can infant feeding choices modulate later obesity risk?, Am J Clin Nutr 2009; 89(5):15025-15085. A change in bottle technology is needed to help reduce the risk of obesity.

Prior art nipples, however, fail to adequately mimic how an infant would nurse on a mother's breast. In other words, bottle feeding an infant using conventional infant bottle assemblies fails to adequately mimic breast feeding the infant. When an infant is placed at the mother's breast to feed, a cascade of events occurs. For one, the infant places their mouth and tongue (latches) with a negative pressure of approximately 30 mm Hg (latching pressure) to the nipple/areola and stimulates milk ejection through a series of quick, shallow sucks referred to as non-nutritive suckling. Non-nutritive suckling consists of stable lengths of sucking bursts and duration of pauses. The average pressure of non-nutritive suckling is approximately 70 to 90 millimeters of mercury (mm Hg) to induce milk ejection from the breast.

When milk ejection begins, the infant collects the milk using strong, relatively even draws, which is known in the art as nutritive suckling. During nutritive suckling the movement of the infant's tongue, jaw, and swallowing facilitates milk flow. The average vacuum pressure applied to the breast during one of the draws is approximately 75-100 mm Hg. The infant will pause between draws to swallow. However, the infant will maintain a latching pressure of about 30 mm Hg while swallowing the collected milk. Thus, the vacuum pressure applied to the breast by the infant fluctuates between the drawing pressure (between about 75-100 mm Hg) and the latching pressure (about 30 mm Hg). As a result, at least some vacuum pressure is applied to the breast by the infant throughout the duration of the nutritive suckling.

However, the vacuum pressure needed to extract liquid from a conventional nipple is substantially lower than that needed to express milk from the breast of a mother. In fact, many nipples allow liquid to exit the bottle via gravity. In addition, these low pressure actuated nipples are susceptible to leaking.

Moreover, many nipples are shaped inappropriately for allowing the infant to use their mouth, tongue and palate in same manner as they would when they are breast feeding. That is, most conventional nipples are inadequately shaped for allowing the infant to latch onto the nipple. The shape of the mother's breast, on the other hand, promotes the proper placement and movement of the infant's mouth when the infant is latched onto the breast.

There is a need, therefore, for a nipple for use with an infant bottle assembly to better simulate the breast of a nursing mother, more effectively facilitates similar oral pressures and movements that occur during feeding from a breast, reduces the potential of leakage, and reduces the potential for over-feeding.

### BRIEF DESCRIPTION

In one aspect, a nipple for use with a nursing bottle is provided. The nipple includes a base portion and a bulbous sidewall connected to and extending upward from the base portion. The bulbous sidewall has a height and a maximum width that is larger than said height. The nipple further includes an end portion extending upward from the bulbous sidewall and having an outlet opening therein.

In another aspect, a nipple for use with a nursing bottle is provided. The nipple includes a base portion positionable proximate the nursing bottle upon assembly therewith, and a bulbous sidewall connected to and extending upward from the base portion. The bulbous sidewall has a height and a maximum width that is larger than said height. The nipple further includes a generally cylindrical end portion extending upward from the bulbous sidewall distal from the base portion and having an outlet opening therein.

In yet another aspect, a nipple for use with a nursing bottle is provided. The nipple includes a base portion positionable proximate the bottle, a bulbous sidewall extending upward from the base portion and having a first height and a maximum width that is larger than the first height, and an end portion extending upward from the bulbous sidewall distal from said base portion and having a second height. The second height is less than the first height. The end portion of the nipple has an outlet opening.

In still another aspect, a nursing bottle assembly is provided. The nursing bottle assembly includes a bottle having a closed bottom, an open top, and a sidewall extending between the bottom and the open top. The bottom and sidewall together define an interior chamber for holding liquid. The nursing bottle assembly further includes a nipple configurable for assembly with the bottle and having an outlet opening through which liquid exits the bottle assembly during use. The nipple includes a base portion configured to interface with the top of the bottle and being open to receive liquid from the interior chamber into the nipple during use of the bottle assembly and a bulbous sidewall connected to and extending upward from the base portion. The bulbous sidewall has a height and a maximum width that is larger than the height. The nipple further includes an end portion extending upward from the bulbous sidewall and having an opening therein defining the nipple outlet opening.

### BRIEF DESCRIPTION OF THE DRAWINGS

FIG. 1 is a perspective of one embodiment of a bottle assembly having a nipple with a flow control valve;

FIG. 2 is an exploded perspective of the bottle assembly;

FIG. 3 is a side elevation of a bottle of the bottle assembly;

FIG. 4 is a top plan view of the bottle;

FIG. 5 is a bottom plan view of the bottle;

FIG. 6 is a side elevation of a cover of the bottle assembly;

FIG. 7 is a top plan view of the cover;

FIG. 8 is a bottom plan view of the cover;

FIG. 9 is a perspective of a nipple of the bottle assembly;

FIG. 10 is a side elevation of the nipple;

FIG. 11 is a top plan view of the nipple;

FIG. 12 is a bottom plan view of the nipple;

FIG. 13 is a perspective of a flow control valve of the bottle assembly;

FIG. 14 is a side elevation of a collar of the bottle assembly;

FIG. 15 is a top plan view of the collar;

FIG. 16 is a bottom plan view of the collar;

FIG. 17 is a perspective of a bottom closure member of the bottle assembly;

FIG. 18 is a side elevation of the bottom closure member;

FIG. 19 is a top plan view of the bottom closure member;

FIG. 20 is a bottom plan view of the bottom closure member;

FIG. 21 is a top plan view of a diaphragm of the bottle assembly;

FIG. 22 is a side elevation of the diaphragm;

FIG. 23 is a cross-section taken along line 23-23 of FIG. 21;

FIG. 24 is a fragmentary perspective of the bottle assembly with portions broken away to show the diaphragm in a sealed position with respect to the bottom closure member;

FIG. 25 is vertical cross-section of the bottle assembly showing the diaphragm in the sealed position with respect to the bottom closure member;

FIG. 26 is a fragmentary perspective of the bottle assembly with portions broken away to show a liquid therein and the diaphragm in an unsealed position with respect to the bottom closure member, the bottle assembly being shown tilted to a drinking position by an infant;

FIG. 27 is a longitudinal cross section of the bottle assembly having the liquid therein and the diaphragm returned to its sealed position with respect to the bottom closure member, the bottle assembly being shown in its tilted, drinking position;

FIG. 28 is an enlarged view taken from FIG. 26 illustrating a fluid control valve disposed within a nipple of the bottle assembly, the fluid control valve being in a closed position; and

FIG. 29 is an enlarged view similar to FIG. 27 but illustrating the fluid control valve in an open position.

Corresponding reference characters indicate corresponding parts throughout the several views of the drawings.

### DETAILED DESCRIPTION OF THE DRAWINGS

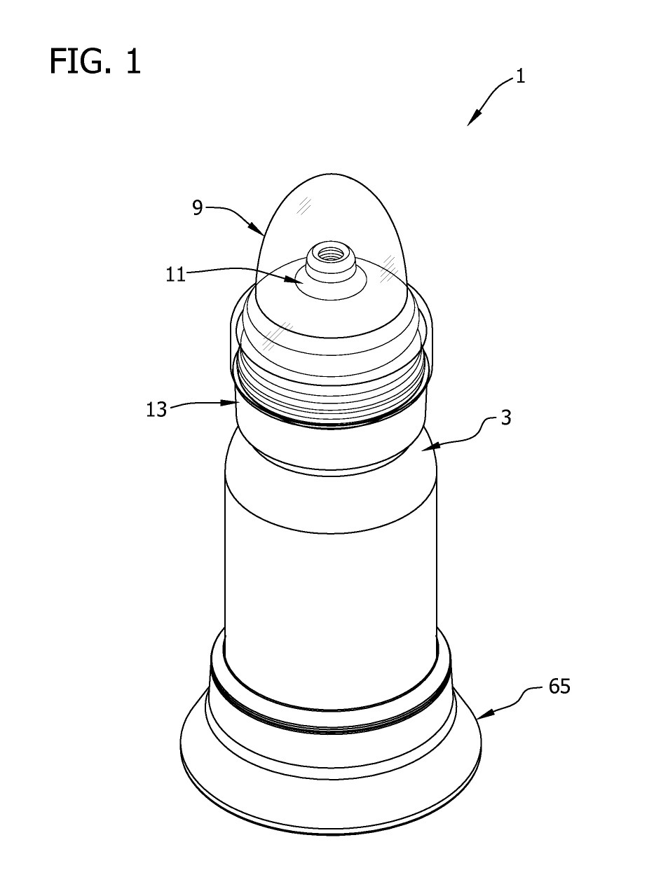

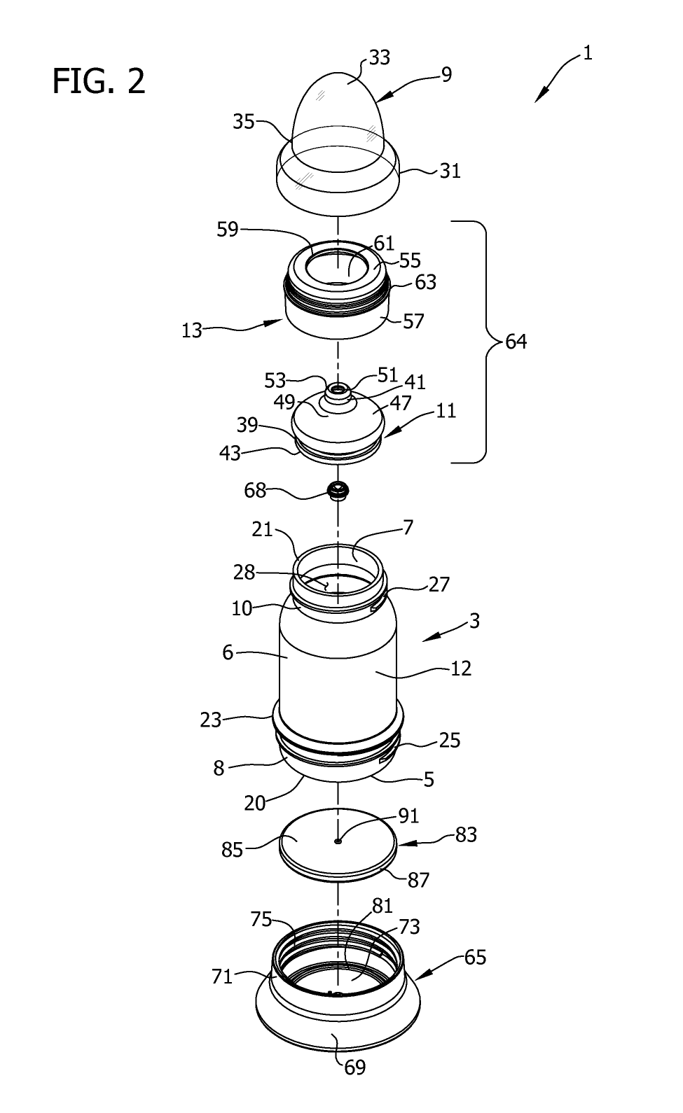

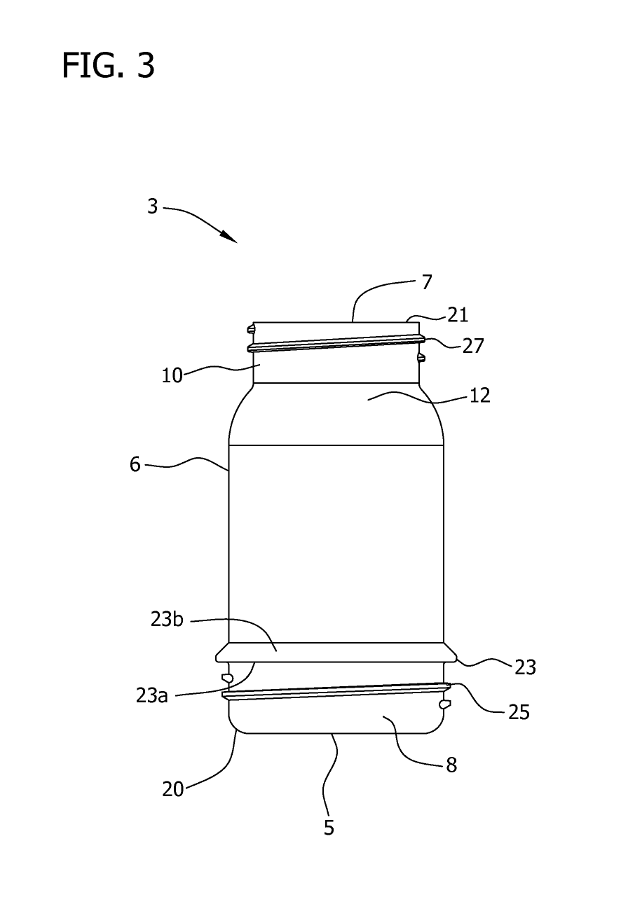

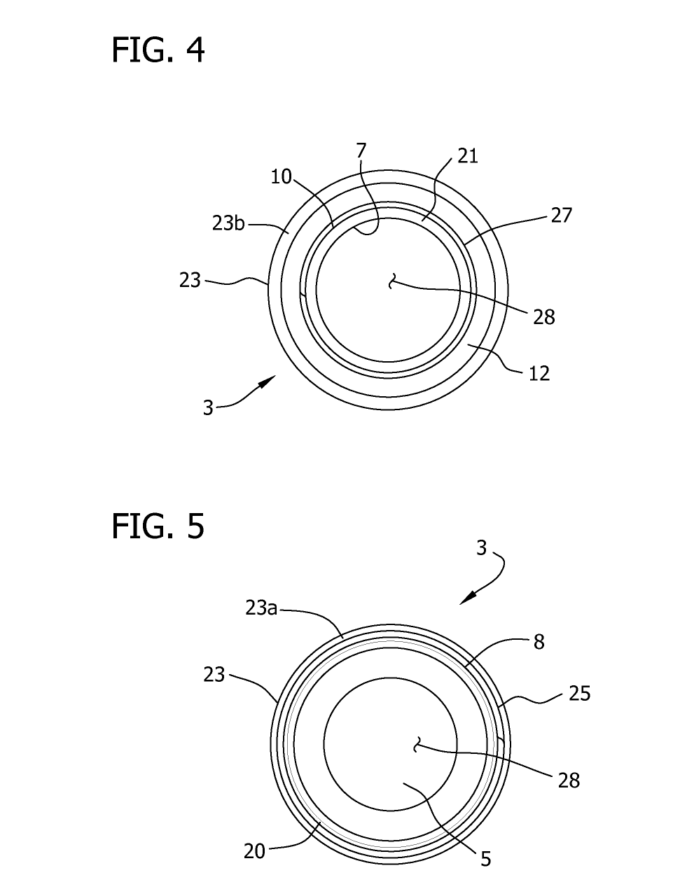

Referring now to the drawings and in particular to FIGS. 1 and 2, a bottle assembly having a nipple with a flow control valve therein is indicated generally at 1. The bottle assembly 1 comprises a bottle 3, a cover 9, a nipple 11, and a collar 13. Each of the bottle, cover, nipple, and collar are indicated generally by their respective reference number. As illustrated in FIGS. 2-5, the bottle 3 has an open bottom 5, an open top 7, and a generally cylindrical side wall 6 extending between the open bottom and the open top. The cylindrical side wall 6 includes a base portion 8, a top portion 10, and a middle portion 12 extending between the base and top portions.

With reference still to FIGS. 2-5, the base portion 8 of the side wall 6 of the bottle 3 is generally cylindrical and includes a circular lower edge 20, an annular rib 23 spaced about the lower edge, and external threads 25 disposed between the lower edge and the annular rib. The annular rib 23 has a generally flat lower surface 23a and a sloped upper surface 23b. The top portion 10 of the side wall 6 is generally cylindrical and has a circular upper edge 21 and external threads 27 spaced below the upper edge. In the illustrated embodiment, the top portion 10 of the bottle 3 has a diameter that is less than the diameters of the middle portion 12 and the base portion 8. As a result of the difference in their diameters, the middle portion 12 has a region that tapers toward the top portion 10. It is understood, however, that the diameters of the top, middle, and base portions 10, 12, 8 can be substantially the same. It is also understood that the middle portion 12 of the bottle 3 could have a diameter less than the top and base portions 10, 8, which would facilitate grasping of the bottle 3 by the user (i.e., infant, young child, caregiver).

The illustrated bottle 3 has a liquid chamber 28 adapted to hold a quantity of liquid for consumption by an infant or a young child. More specifically, the illustrated bottle 3 is adapted for use by an infant and to hold approximately 6 ounces of liquid (e.g., milk, breast milk, formula, water, juice). The bottle 3 can be made of any suitable material (e.g., plastic, glass, stainless steel, aluminum) and can be made in any desired color or colors, and may be transparent, translucent, or opaque. In one suitable embodiment, the bottle 3 is made from plastic and manufactured using an injection mold process, which provides greater control over the thickness of the bottle as compared to a blown mold process. It is understood that the bottle 3 can have different configurations than those illustrated herein (e.g., a sports bottle, a travel cup, a training or sippy cup) and sized to hold quantities of liquid besides 6 ounces (e.g., 2 ounces, 4 ounces, 9 ounces, 12 ounces, etc.).

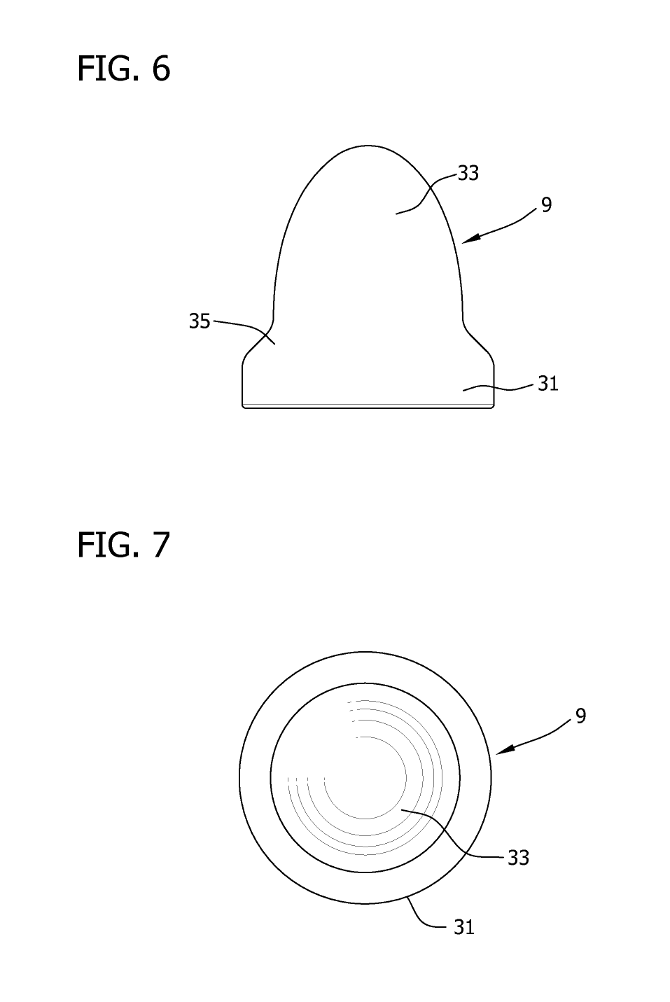

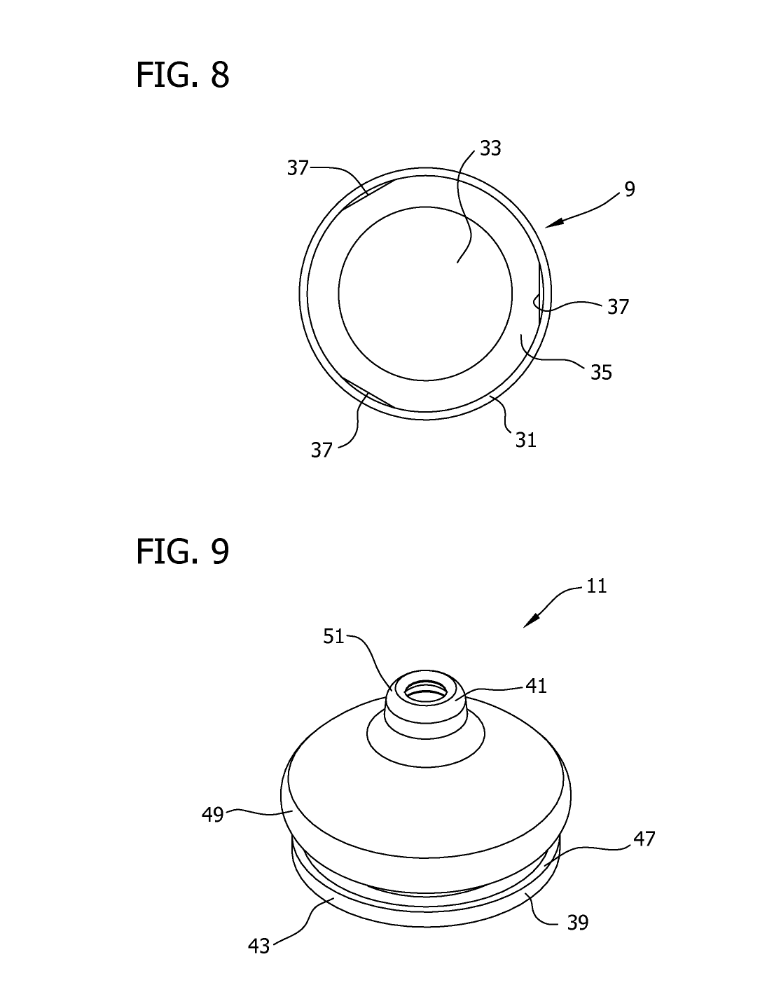

The cover 9, which is illustrated in FIGS. 6-8, is removeably securable to the collar 13 (FIGS. 1 and 2) via a snap-fit connection but it is understood that other types of suitable connections can be used (e.g., a threaded connection). As best seen in FIGS. 2 and 6, the cover 9 has a lower cylindrical portion 31, a domed upper portion 33, and a sloped intermediate or transition portion 35 that extends between the lower portion and the upper portion. In the illustrated embodiment, the lower portion 31 has three inward extending tabs 37 adapted for releasable snap-fit connection with the collar 13. The three tabs 37 can be seen in FIG. 8. As a result, the cover 9 can be selectively secured to the collar 13 during periods of non-use (e.g., storage, travel) to cover the nipple 11 (FIGS. 1 and 2) and removed during periods of use for providing access to the nipple. The cover 9 can be made of any suitable material, such as polypropylene, and can be made in any desired color or colors, and may be transparent (as illustrated), translucent, or opaque. It is contemplated that the cover 9 can be omitted from the bottle assembly 1. It is understood that the cover 9 can have more or fewer tabs 37 than the three seen in the illustrated embodiment.

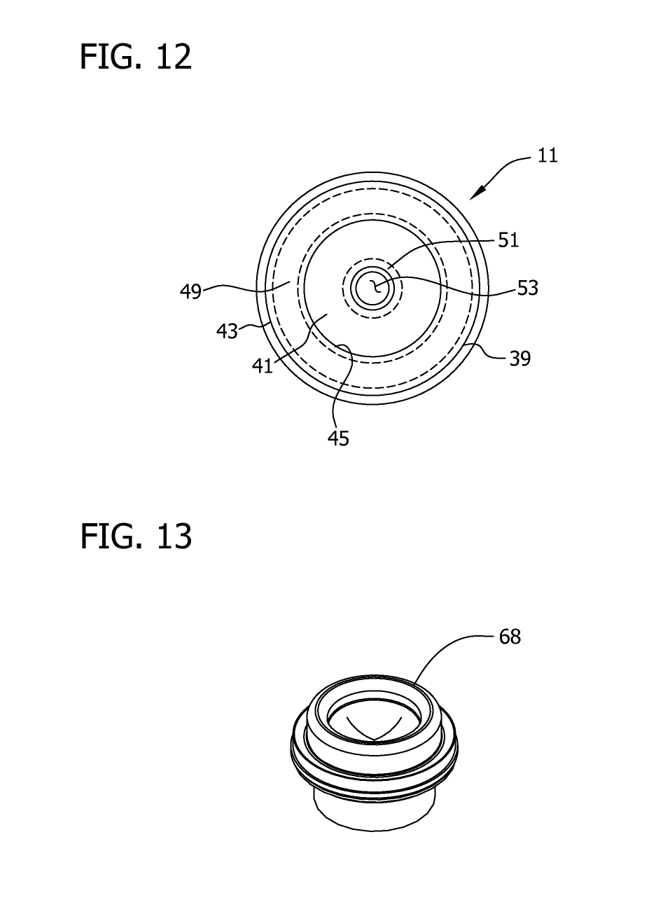

With reference to FIGS. 2 and 9-12, the nipple 11 includes a base portion 39 and a nipple portion 41 that extends up from the base portion. The base portion 39 comprises an annular flange having a generally circular outer edge 43 and a generally circular inner edge 45. In the illustrated embodiment, a continuous, peripheral lip 47 projects up from the flange generally adjacent the circular outer edge 43 of the base portion 39. It is understood that the peripheral lip 47 can be discontinuous (i.e., formed from two or more discrete segments) or even omitted from the base portion 39.

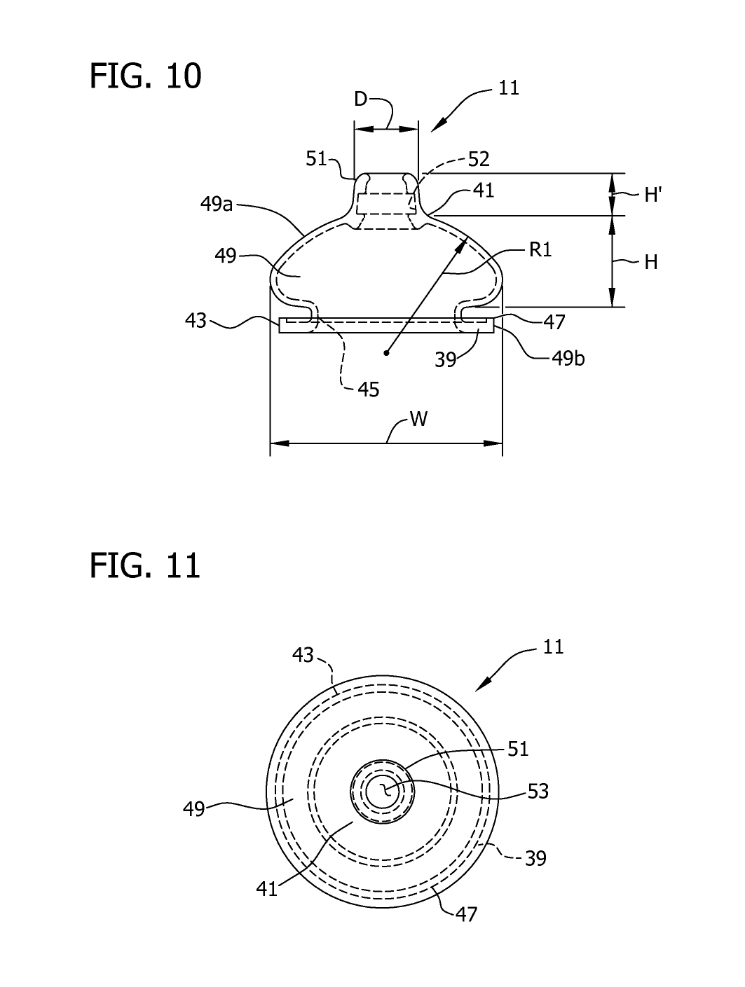

The nipple portion 41 of the nipple 11 extends up from the base portion 39 generally adjacent the circular inner edge 45 thereof As seen in FIG. 10, the nipple portion 41 includes a generally bulbous sidewall 49 and a generally cylindrical end 51 extending upward from the bulbous sidewall. The cylindrical end 51 has an opening 53 therein. In the illustrated embodiment, the bulbous sidewall 49 has an upper tapered portion 49a that is slightly convex and has a radius R1 of about 35 mm. It is understood, however, that the upper tapered portion 49a can have any suitable radius R1 without departing from the scope of this invention.

As seen in FIG. 10, the bulbous sidewall 49 has a height H and a width W (i.e., diameter) at its widest part that is substantially greater than its height. In the illustrated embodiment, for example, the width W of the bulbous sidewall 49 is approximately twice that of the height H of the sidewall. More specifically, the height H of the bulbous sidewall 49 of the nipple 11 is about 21 mm and the widest part of the sidewall has a width W of about 42 mm. As a result, the upper tapered portion 49a of the bulbous sidewall 49 tapers from the cylindrical end 51 downward toward the widest portion of the sidewall, and a lower tapered portion 49b that tapers from the widest portion of the sidewall inward to proximate the base portion 39. It is contemplated that the widest part of the bulbous sidewall 49 may have any suitable width and height without departing from the scope of this invention.

The cylindrical end 51 of the nipple 11 has a height H′ such that a diameter-to-height ratio of the cylindrical end is between about 1.15 and about 1.6. For example, the diameter D and the height H′ of the cylindrical end are about 13-16 mm and about 10 mm, respectively. It is contemplated that the cylindrical end 51 can have any suitable diameter and height (i.e., diameter-to-height ratio) without departing from the scope of this invention. The illustrated cylindrical end 51 has one generally circular opening 53 therein but it is understood that more openings can be provided in the bulbous end and that the openings can have one or more different shapes (e.g., square, triangle, oval, slits) without departing from the scope of this invention. As seen in FIG. 10, the cylindrical end 51 of the nipple 11 includes an interior annular recess 52 suitably sized for capturing a flow control valve as explained in more detail below.

The nipple 11 of the illustrated embodiment is configured to generally resemble a human female's breast. More specifically, the cylindrical end 51 is configured to resemble the nipple of a human breast and the bulbous sidewall 49 is configured to resemble the portions of the human breast surrounding the nipple (e.g., areola, skin). As a result, the infant using the disclosed nipple 11 is able to latch onto the nipple as he/she would their mother's breast. It is contemplated, however, that the nipple 11 can have different shapes and sizes than those illustrated and described herein without departing from some aspects of this invention.

In one suitable embodiment, the nipple 11 is fabricated from a substantially pliable material such as at least one of a rubber material, a silicone material, and a latex material. It is contemplated, however, that the nipple 11 may be fabricated from any suitable material without departing from the scope of this invention. The illustrated nipple 11 is suitably transparent or translucent but it is understood that the nipple may instead be opaque.

A suitable flow control valve, such as the flow control valve 68 illustrated in FIG. 13, is disposed in the nipple 11 for regulating the flow of liquid from the liquid chamber 28 of the bottle 3, through the nipple 11 and out the opening 53 in the nipple. In the illustrated embodiment, the flow control valve 68 is captured by the annular recess 52 in the cylindrical end 51 of the nipple 11 and spaced from the opening 53 in the nipple 11. In this embodiment, the flow control valve 68 is formed separately from the nipple 11, inserted into the annular recess 52, and bonded thereto. It is understood, however, that the flow control valve 68 can be formed (e.g., molded) integrally with the nipple 11. One suitable flow control valve 68 is the SureFlo® elastomeric valve available from Liquid Molding Systems, Inc. (LMS) of Midland, Mich., U.S.A.

In one embodiment, the flow control valve 68 is configured to open when a predetermined external vacuum pressure is applied to the valve by the user via sucking (broadly, “opening pressure”) is in a range between about 30 mm Hg and about 100 mm Hg. In one suitable embodiment, the valve 68 is configured to open when the vacuum pressure applied to the valve is approximately 50 mm Hg. The flow control valve 68 is also configured to close when the vacuum pressure applied to the valve by the user via sucking (broadly, “closing pressure”) falls to or slightly below the opening pressure (e.g., approximately 50 mm Hg in the illustrated embodiment). It is contemplated, however, that the flow control valve 68 can be configured to open and close at any suitable vacuum pressures besides those disclosed herein. As a result of the significant external vacuum pressure needed to open the flow control valve 68 and thereby allow liquid to flow therethrough, the flow control valve substantially reduces the potential for leakage through the nipple 11.

The nipple 11 having the disclosed flow control valve 68 better simulates how milk is drawn from a female's breast. During nutritive suckling, an infant collects milk being ejected using strong, even draws followed by a brief pause for swallowing. Thus, the infant cyclically sucks to draw milk into his/her mouth and pauses to swallow the collected milk. The flow of milk from the human breast is not continuous but instead flows when the infant applies sufficient vacuum in combination with proper mouth movements. Moreover and as discussed above, the shape of the female nipple and portions of the breast surrounding the nipple promotes proper placement, latching and movement of the infant's mouth.

Thus, the nipple 11 disclosed herein is configured to better simulate a breast feeding event. In the illustrated embodiment, the flow control valve 68 is configured to open and close when the vacuum pressure applied to the nipple by the infant is approximately 50 mm Hg. As a result, as long as the infant applies a vacuum pressure above 50 mm Hg, liquid will flow through the nipple and into the infant's mouth for consumption. If the vacuum pressure applied by the infant to the nipple via sucking falls to or slightly below 50 mm Hg, the liquid will stop flowing through the flow control valve 68. In one suitable embodiment, the flow control valve 68 is configured for allowing a flow rate of about 7 milliliters per minute (ml/min) to about 15 ml/min based on the assumption that the infant cycles between draws and pauses about 60 times per minute. It is contemplated that the flow control valve 68 can be configured to operate at any suitable opening or closing pressure and at any suitable flow rate.

Accordingly, the present nipple 11 having the combination of its breast-like shape and the flow control valve 68 therein better simulates the feeding of an infant from a breast of a nursing mother and more effectively allows the infant to use oral pressures and movements that are similar to those used during feeding from a breast as compared to prior art nipples.

The flow control valve 68 is also adapted to open when the liquid chamber of the bottle is subjected to a predetermined internal vacuum pressure. In the illustrated embodiment, for example, the flow control valve 68 will open when the vacuum pressure within the liquid chamber reaches or exceeds approximately 10 mm Hg and allow ambient air to flow into the liquid chamber.

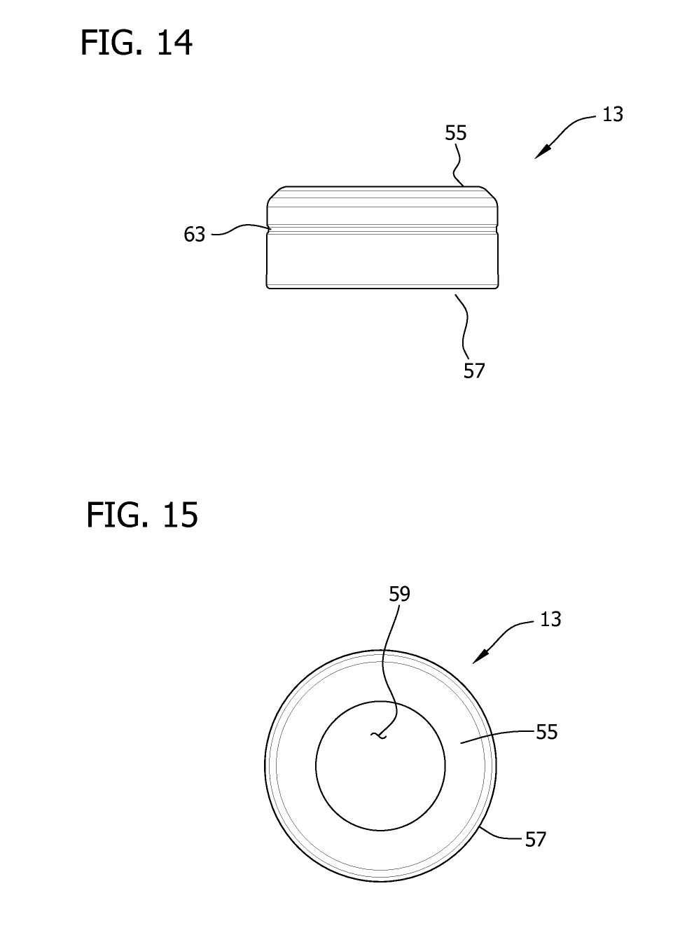

Referring now to FIGS. 14-16, the collar 13 includes a generally flat upper portion 55 and a cylindrical skirt 57 depending downward from the upper portion. The upper portion 55 includes a generally circular opening 59 therein for allowing the nipple portion 41 of the nipple 11 to pass through the collar 13 as illustrated in FIG. 1. As seen in FIG. 16, the skirt 57 includes internal threads 61 that are adapted for mating with the external threads 27 (FIG. 2) of the top portion 10 of the bottle 3 for selectively securing the collar 13 and the nipple 11 to the bottle assembly 1. With reference to FIG. 14, the collar 13 also includes an external channel 63 sized for receiving the tabs 37 of the cover 9 when the cover is secured thereto. The tabs 37 of the cover 9 and the channel 63 of the collar 13 collectively define the snap-fit connection therebetween.

In the illustrated embodiment, the nipple 11 and the collar 13 collectively define a top closure member, indicated generally at 64, for closing the open top 7 of the bottle 3 (FIG. 2). It is contemplated, however, that the top closure member 64 can have a different configuration than that illustrated herein. For example, the top closure member 64 can have any configuration suitable for used with, e.g., a nursing bottle, a sports bottle, a travel cup, a training cup, and/or a sippy cup.

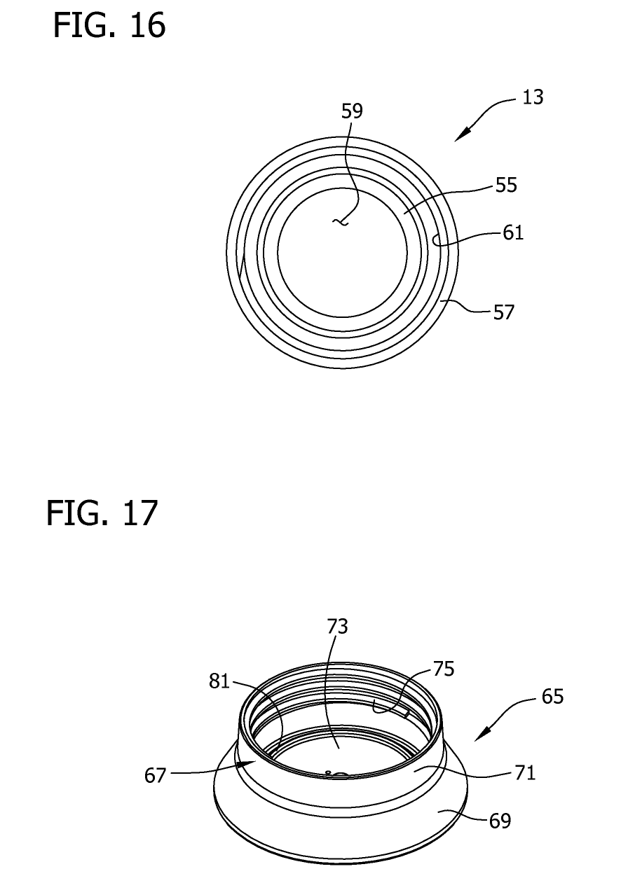

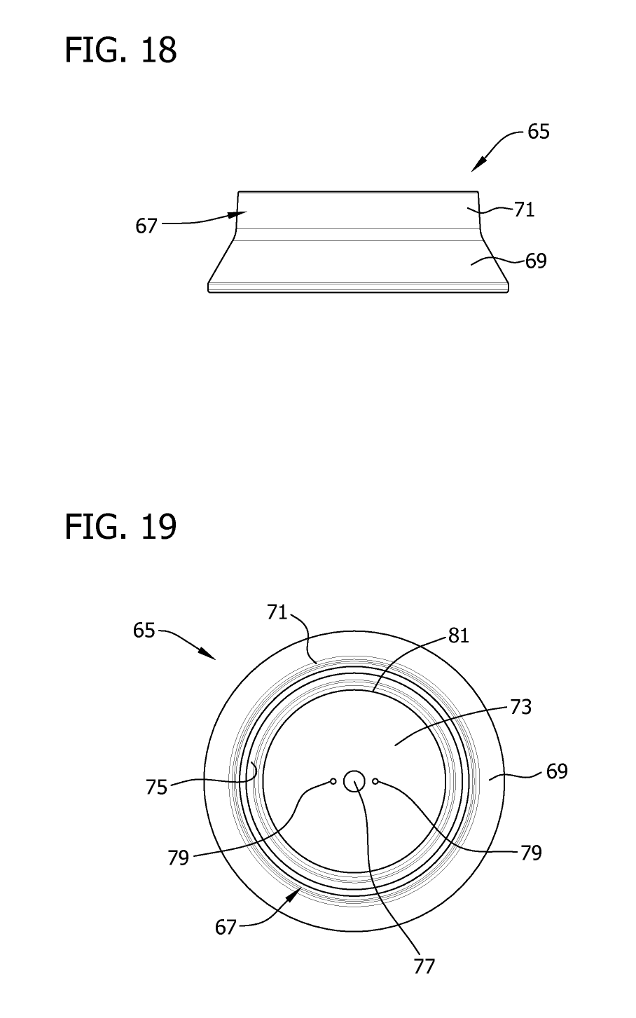

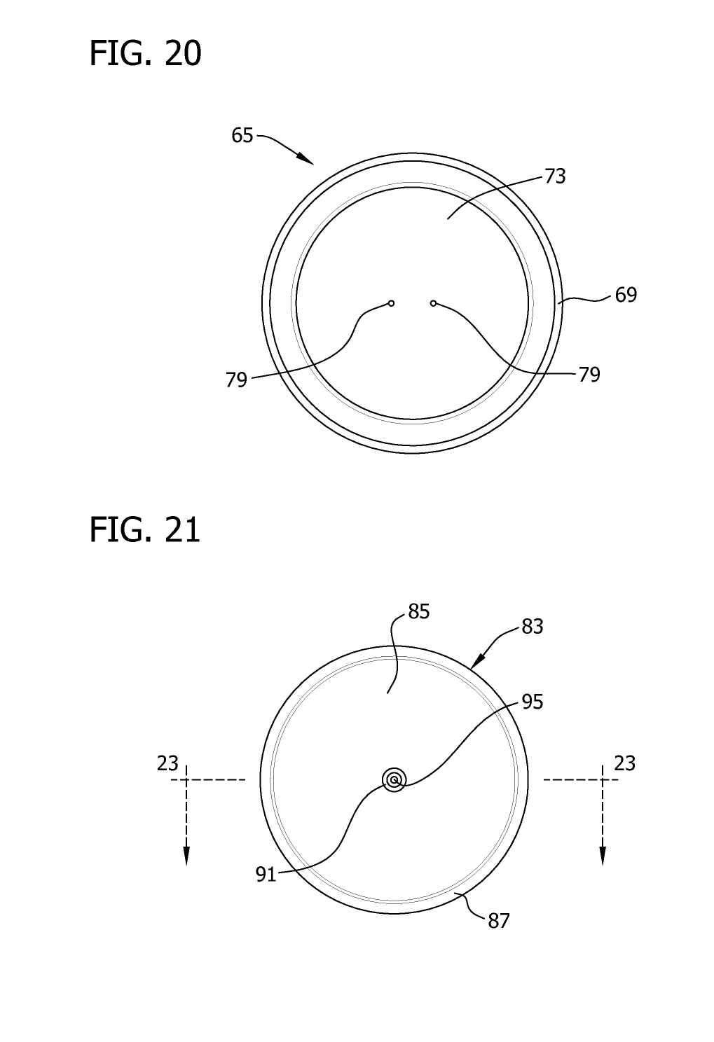

Referring briefly back to FIGS. 1 and 2, the bottle assembly 1 further comprises a bottom closure member 65 for closing the open bottom 5 of the bottle 3. As seen in FIGS. 17-20, the bottom closure member 65 includes a generally cup-shaped socket, indicated generally at 67, and a tapered foot 69 extending downward and outward from the socket. The tapered foot 69 provides a stable base for the bottle assembly 1 when the bottle assembly is placed on a generally flat surface (e.g., a counter top, a table) to thereby inhibit tipping of the bottle assembly.

The cup-shaped socket 67 includes a cylindrical wall 71 and a base panel 73 closing a bottom end of the cylindrical wall. The cylindrical wall 71 has internal threads 75 for mating with the external threads 25 (FIG. 2) on the base portion 8 of the bottle 3. Accordingly and as explained in more detail below, the bottom closure member 65 can be selectively coupled to and selectively decoupled from the bottle 3 via the threaded connection therebetween. As seen in FIG. 19, the base panel 73 has a centrally located circular seat 77, two circular apertures 79 located adjacent the seat, and an annular shoulder 81. While the seat 77 in the illustrated embodiment is circular, it is understood that the seat can have other shapes (e.g., square, hexagonal). It is also understood that, in some suitable embodiments, the seat 77 can be omitted. It is further understood that the apertures 79 can have shapes other than circular and that more or fewer apertures can be located in the base panel 73. The annular shoulder 81 is disposed on an upper surface of the base panel 73 at a location generally adjacent to and transversely inward from the cylindrical wall 71. In the illustrated embodiment, the base panel 73 is generally flat but it is understood that the base panel could have other suitable shapes (e.g., conical, frustum, domed). It is also understood that the base panel 73 can include suitable reinforcing members (e.g., ribs).

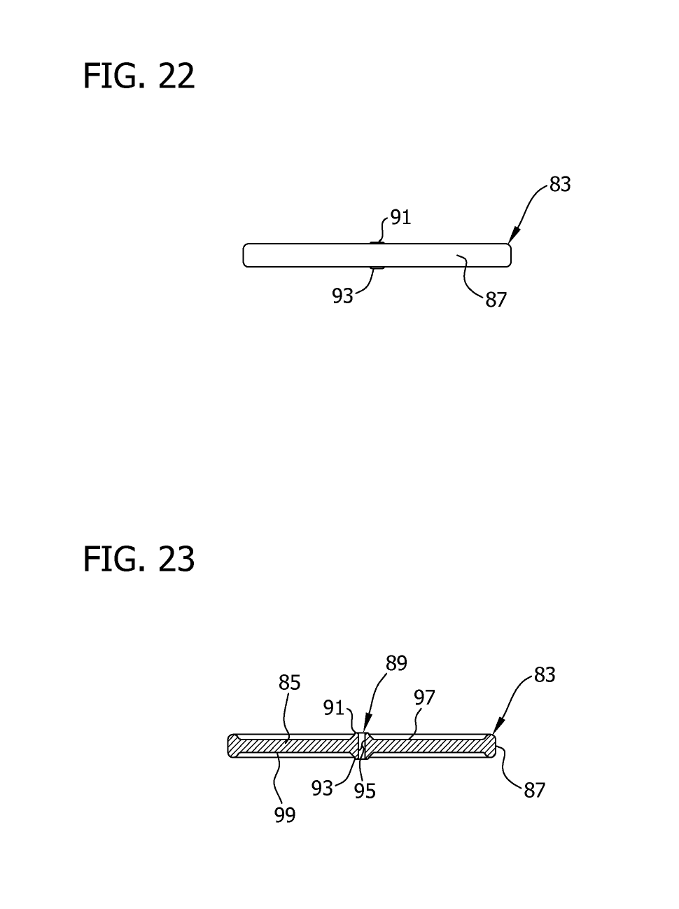

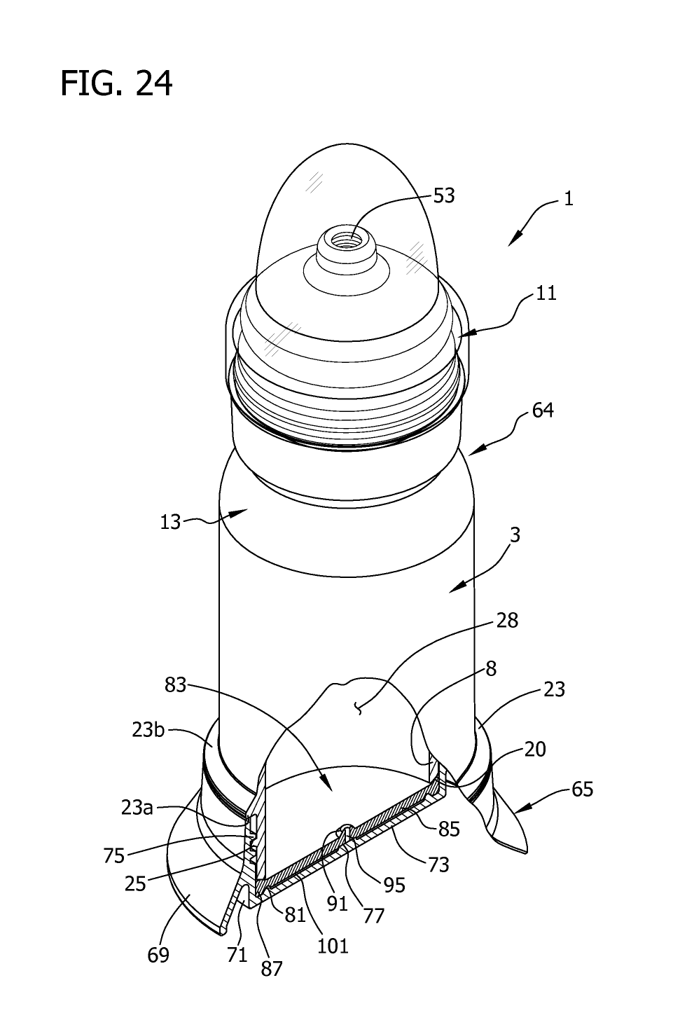

With reference now to FIGS. 21-24 (and in particular to FIG. 24), the bottle assembly 1 further comprises a diaphragm (broadly, a “vent member”), indicated generally at 83, disposed between the lower edge 20 of the bottle 3 and the bottom closure member 65. The diaphragm 83 closes the open bottom 5 (FIG. 2) of the bottle 3. The diaphragm 83 has a roughly disk-shaped portion 85, an annular rim 87 circumscribing the disk-shaped portion, and a central seating member, indicated generally at 89. The central seating member 89 comprises first and second sealing elements 91, 93 that project outward from the disk-shaped portion 85, and a central air passage 95 that extends axially through the diaphragm 83. As seen in FIG. 22, each of the first and second sealing elements 91, 93 of the diaphragm 83 are generally frustum and coaxially aligned with the air passage 95 and each other. As a result, the air passage 95 extends through each of the first and second sealing elements 91, 93. The diaphragm 83 is symmetric in that it has a first side 97 and a substantially identical second side 99 (FIG. 23). As a result, the diaphragm 83 is positionable in the bottom closure member 65 with either side 97, 99 facing up.

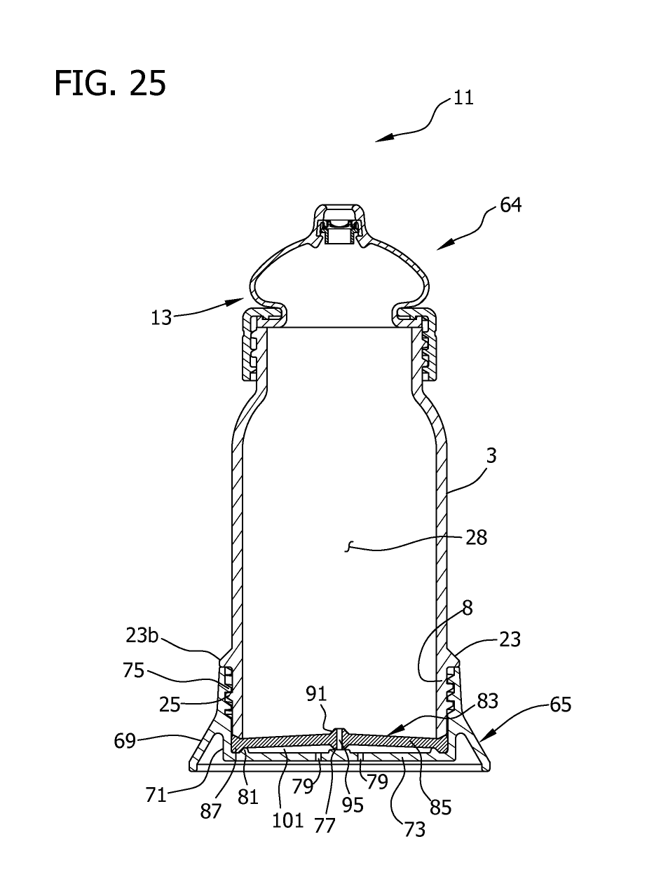

As illustrated in FIGS. 24 and 25, the diaphragm 83 is captured between the bottom closure member 65 and the base portion 8 of the bottle 3. More specifically, the diaphragm 83 is inserted into the cup-shaped socket 67 (FIG. 17) of the bottom closure member so that one of the first and second sealing elements 91, 93 rest on the seat 77 of the base panel 73 of the bottom closure member 65 and the annular rim 87 of the diaphragm is disposed adjacent a lower portion of the cylindrical wall 71 outward of the annular shoulder 81 of the bottom closure member. The bottom closure member 65 is screwed onto the bottle 3 via the interior threads 75 of the bottom closure member and the external threads 25 of the base portion 8 on the bottle. In doing so, the lower edge 20 of the bottle 3 engages a portion of the diaphragm 83 at a location generally opposed to the annular shoulder 81 of the bottom closure member to thereby pinch the diaphragm between the bottle and the bottom closure member to form a liquid tight seal. As seen in FIG. 25, an air gap 101 is formed between the diaphragm 83 and the base panel 73 of the bottom closure member 65. Moreover, the diaphragm 83 is slightly bowed upward at its center when it is captured between the bottom closure member 65 and the bottle 3. This causes the diaphragm, which is resilient, to be biased toward the base panel 73 of the bottom closure member 65. More specifically, bowing the diaphragm 83 upward at its center causes one of the first and second sealing elements 91, 93 to be biased against the seat 77 of the base panel 73 of the bottom closure member 65.

The bottle assembly 1 can be repeatedly taken apart for thorough cleaning (FIG. 2) and reassembled for the next use (FIG. 1). The separable components of the bottle assembly 1 are all relatively large so that they are easy to handle, are not easily lost, and pose a reduced risk of danger to small children. In addition, the number of separable components is minimized to make assembly and reassembly of the bottle assembly 1 relatively easy.

As mentioned above, the cover 9 can be selectively removed from the bottle assembly 1 via its snap-fit connection with the collar 13. Thus, a user of the bottle assembly can remove the cover 9 by manually pulling the cover off of the collar 13. The collar 13 can be removed from the bottle assembly 1 by disengaging the threaded connection between the collar and the bottle 3. More specifically, the collar 13 can be manually rotated with respect to the bottle 3 to thereby disengage the internal threads 61 of the collar from the external threads 27 of the top portion 10 of the bottle 3. Since the nipple 11 is captured by the collar 13, removal of the collar from the bottle assembly 1 results in removal of the nipple as well. The bottom closure member 65 can also be manually rotated with respect to the bottle 3 to thereby disengage internal threads 75 from the external threads 25 on the base portion 8 of the bottle 3. Since the diaphragm 83 is captured by the bottom closure member 65, removal of the bottom closure member from the bottle assembly 1 results in removal of the diaphragm as well. Once the bottom closure member 65 and diaphragm 83 are disengaged from the bottle 3, the diaphragm 83 can be manually lifted from the bottom closure member 65. Otherwise, the bottom closure member 65 can be turned upside down and the diaphragm 83 will fall out.

Thus, all of the components of the illustrated bottle assembly 1 can be easily separated and cleaned either manually or in a dishwasher. The bottle assembly 1 can be easily reassembled by reversing the disassembling process.

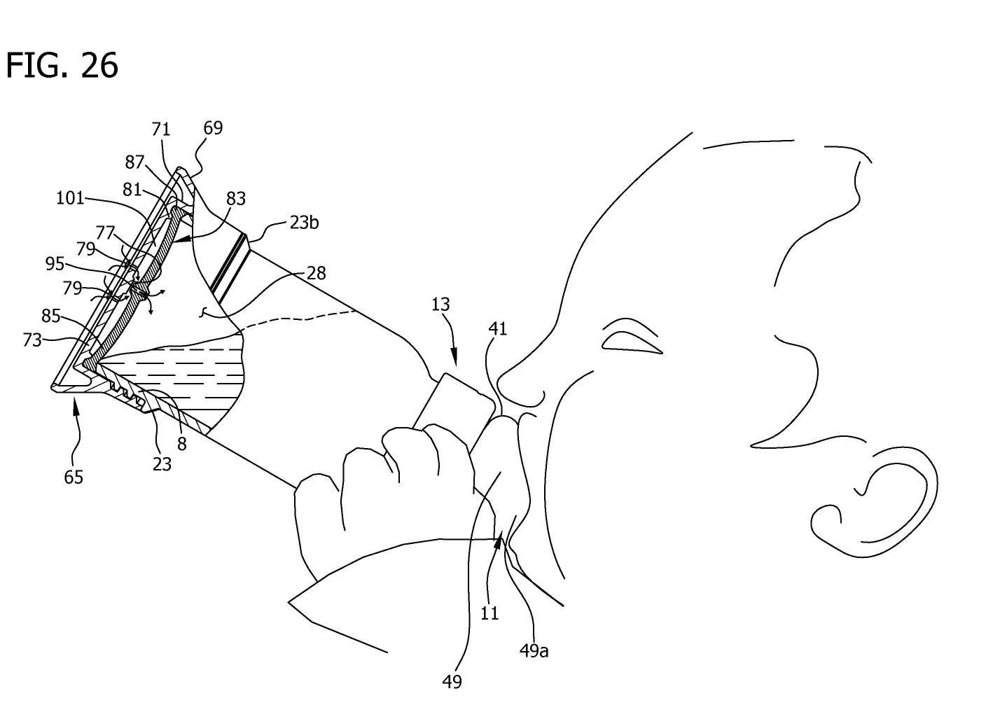

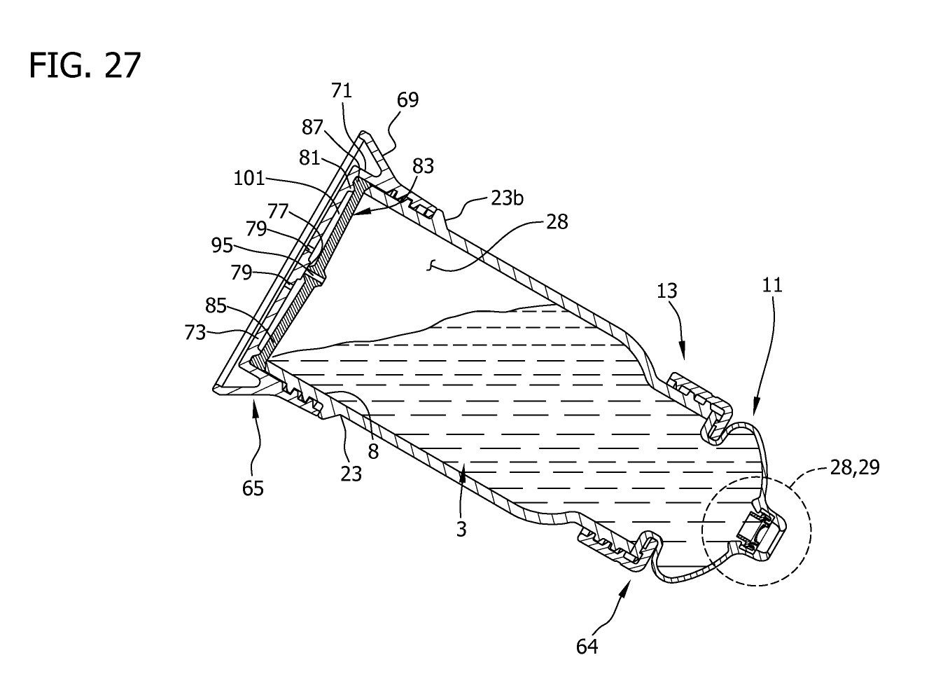

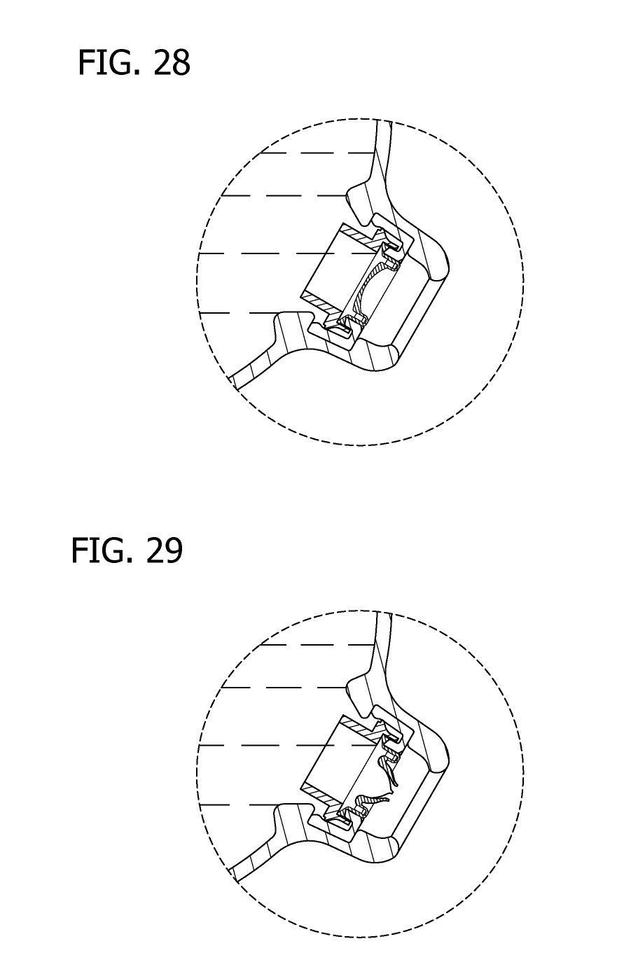

As illustrated in FIG. 26, an infant (or young child) can drink from the bottle assembly 1 by latching onto the upper tapered portion 49a of the bulbous sidewall 49 of the nipple 11 with his/her lips as he/she would a breast. As illustrated, the cylindrical end 51 of the nipple 11 with the flow control valve 68 disposed therein is entirely received within the infant's mouth. The infant tilts the bottle assembly 1 to a drinking position thereby causing liquid to flow via gravity into the nipple 11 where is it blocked by the flow control valve 68 (FIGS. 27 and 28). Next, the infant sucks to apply a vacuum to the nipple 11 and thereby to the flow control valve 68. Once the vacuum pressure reaches or exceeds about 50 mm Hg, the flow control valve 68 will open as seen in FIG. 29 and allow the liquid to pass from the liquid chamber 28 of the bottle 3 through the flow control valve and out the opening 53 in the nipple 11 for consumption by the infant. Once the vacuum pressure applied by the infant falls to or below the 50 mm Hg needed to keep the flow control valve 68 open (e.g., when the infant pauses to swallow), the flow control valve will move back to the closed position blocking the flowing of liquid. A typically infant will cycle between sucks and pauses to swallow about 60 times per minute. Thus, it is anticipated that the flow control valve 68 will open and close about 60 times per minute during a typically feeding.

Sucking on the nipple 11 and removing liquid from the liquid chamber 28 of the bottle 3 causes an internal vacuum to form within the liquid chamber. That is, the infant drinking liquid from the bottle assembly 1 causes the pressure within the liquid chamber 28 of the bottle 3 to drop below ambient pressure. In one suitable embodiment, more than 50% of the surface area of the first side 97 of the diaphragm 83 is subjected to the vacuum within the bottle 3 and more than 50% of the surface area of the second side 99 of the diaphragm is subjected to ambient pressure during use. Suitably more than 75% and even more suitably more than 90% of the surface areas of the first and second surfaces are subjected to vacuum and ambient pressure, respectively, during use. As a result, the diaphragm 83 is responsive to relatively low pressure differentials (i.e., the pressure difference between the liquid chamber 28 of the bottle 3 and ambient pressure) thereby making it easy for the infant to drink from the bottle assembly 1. In one suitable embodiment, the diaphragm 83 is responsive to pressure differentials between about 2 (0.15 mm Hg) and about 4 inches of water (0.30 mm Hg). However, it is understood that the diaphragm 83 can be responsive to other ranges of pressure differentials.

The vacuum formed within the liquid chamber 28 of the bottle 3 draws the diaphragm 83 to move from a sealed position (FIG. 25) to an unsealed position (FIG. 26). More specifically, the vacuum causes the diaphragm 83 to flex away from the base panel 73 of the bottom closure member 65 thereby opening an air vent and allowing air (as indicated by the arrows in FIG. 25) into the liquid chamber 28 of the bottle 3. Particularly, flexure of the diaphragm 83 repositions the outer facing one of the first and second sealing elements 91, 93 away from the seat 77 of the base panel 73 of the bottom closure member 65 to allow air to flow in through two apertures 79 in the base panel of the bottom closure member, into the air gap 101 formed between the diaphragm 83 and bottom closure member, through the air passage 95 in the diaphragm, and into the liquid chamber 28 of the bottle 3. As the vacuum pressure within the liquid chamber 28 of the bottle 3 approaches ambient pressure, the resiliency of the diaphragm 83 causes it to move back to the sealed position thereby preventing further air flow into the liquid chamber. Particularly, the outer facing one of the first and second sealing elements 91, 93 of the diaphragm 83 return to the seated position wherein the respective sealing element sealingly engages the seat 77 of the base panel 73 of the bottom closure member 65 and thereby blocks air flow into the liquid chamber 28 of the bottle 3.

Air is trapped in the air passage 95 in the diaphragm 83 when the outer facing one of the first and second sealing elements 91, 93 of the diaphragm 83 is sealingly seated against the seat 77 of the base panel 73 of the bottom closure member 65. This trapped air inhibits liquid contained in the liquid chamber 28 of the bottle 3 from entering the air passage 95 in the diaphragm. Inhibiting liquid from entering the air passage 95 in the diaphragm 83 significantly reduces the likelihood that liquid contained in the liquid chamber 28 of the bottle 3 will leak from the bottle assembly 1.

Should the vacuum within the liquid chamber 28 of the bottle 3 reach or exceed approximately 10 mm Hg during use (e.g., if the vent member fails), the flow control valve 68 will allow air to flow through the valve and into the liquid chamber of the bottle.

As various changes could be made in the above constructions and methods without departing from the scope of the invention, it is intended that all matter contained in the above description and shown in the accompanying drawings shall be interpreted as illustrative and not in a limiting sense.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. A nipple for use with a nursing bottle, the nipple comprising:
a base portion;
a bulbous sidewall connected to and extending upward from the base portion, the bulbous sidewall having a height and a maximum width that is larger than said height; and
an end portion extending upward from the bulbous sidewall and having an outlet opening therein.

2. The nipple as set forth in claim 1, wherein the maximum width of the bulbous sidewall is approximately two times the height of the bulbous sidewall.

3. The nipple as set forth in claim 1, wherein the bulbous sidewall comprises an upper tapered portion adjacent the end of the nipple, the upper tapered portion being convex as it extends away from said end of the nipple.

4. The nipple as set forth in claim 3, wherein the upper tapered portion of the bulbous sidewall has a radius that is greater than the height of the bulbous sidewall.

5. The nipple as set forth in claim 1, wherein the bulbous sidewall comprises a lower tapered portion that tapers from the maximum width inward to proximate the base portion.

6. The nipple as set forth in claim 1, wherein the end of the nipple portion has a height, a ratio of the height of the bulbous sidewall to the height of the end of the nipple being about 2.

7. The nipple as set forth in claim 1, wherein the end of the nipple comprises an inner recess defined therein proximate the outlet opening, the nipple further comprising a flow control valve disposed within the inner recess, the flow control valve being configured to regulate a flow of liquid from the bottle through the outlet opening of the end of the nipple.

8. A nipple for use with a nursing bottle, the nipple comprising:
a base portion positionable proximate the nursing bottle upon assembly therewith;
a bulbous sidewall connected to and extending upward from the base portion, the bulbous sidewall having a height and a maximum width that is larger than said height; and
a generally cylindrical end portion extending upward from the bulbous sidewall distal from the base portion and having an outlet opening therein.

9. The nipple as set forth in claim 8, wherein the cylindrical end portion has a diameter and a height, a ratio of said diameter to said height of the end portion being between about 1.15 and about 1.6.

10. The nipple as set forth in claim 8, wherein the height of the cylindrical end portion is about 10 millimeters.

11. The nipple as set forth in claim 8, further comprising a flow control valve coupled within the cylindrical end portion, the flow control valve configured to regulate a flow of liquid from the nursing bottle through the outlet opening in the cylindrical end portion of the nipple.

12. A nipple for use with a nursing bottle, the nipple comprising:
a base portion positionable proximate the bottle;
a bulbous sidewall extending upward from the base portion and having a first height and a maximum width that is larger than the first height; and
an end portion extending upward from the bulbous sidewall distal from said base portion and having a second height, said second height being less than said first height, the end portion of the nipple having an outlet opening.

13. The nipple as set forth in claim 12, wherein a ratio of the first height to the second height is about 2.

14. The nipple as set forth in claim 12, wherein the first height is about 21 millimeters and the second height is about 10 millimeters.

15. The nipple as set forth in claim 12, wherein the end portion is generally cylindrical and has a diameter between about 13 millimeters and about 16 millimeters, said second height of the end portion being about 10 millimeters.

16. A nursing bottle assembly comprising:
a bottle having a closed bottom, an open top, and a sidewall extending between the bottom and the open top, said bottom and sidewall together defining an interior chamber for holding liquid;
a nipple configurable for assembly with the bottle and having an outlet opening through which liquid exits the bottle assembly during use, the nipple comprising:
a base portion configured to interface with the top of the bottle and being open to receive liquid from the interior chamber into the nipple during use of the bottle assembly;
a bulbous sidewall connected to and extending upward from the base portion, the bulbous sidewall having a height and a maximum width that is larger than said height; and
an end portion extending upward from the bulbous sidewall and having an opening therein defining the nipple outlet opening.

17. The bottle assembly as set forth in claim 16, wherein the maximum width of the bulbous sidewall is approximately two times the height of the bulbous sidewall.

18. The bottle assembly as forth in claim 16, wherein the bulbous sidewall comprises:
an upper tapered portion adjacent the end portion of the nipple, the upper tapered portion tapering from the said end portion as it extends toward a location of the maximum width of the bulbous sidewall; and
a lower tapered portion that tapers as it extends from the location of maximum width to proximate the base portion.

19. The bottle assembly as forth in claim 16, wherein the end portion comprises:
an annular recess defined in the end portion proximate the outlet opening; and
a flow control valve disposed within the annular recess, the flow control valve configured to regulate a flow of liquid from the bottle through the outlet opening.

20. The bottle assembly as forth in claim 16, further comprising a vent member configured to allow air to pass into the bottle during use.
